(19) United States
(12) Patent Application Publication
(10) Pub. No.: US 2023/0289254 A1
(43) Pub. Date: Sep. 14, 2023

(54) METHOD AND APPARATUS FOR PROCESSING AT LEAST ONE ACTIVITY REGARDING A PHYSICAL ENTITY

(71) Applicant: Telefonaktiebolaget LM Ericsson (publ), Stockholm (SE)

(72) Inventor: Ning ZHANG, Beijing (CN)

(21) Appl. No.: 18/018,929

(22) PCT Filed: Aug. 14, 2020
(86) PCT No.: PCT/CN2020/109240

§ 371 Date: Jan. 31, 2023

(51) Int. Cl. G06F 11/07; H04L 43/08

(52) U.S. Cl. CPC G06F 11/079; G06F 11/0709; G06F 11/0748; H04L 43/08

(57) ABSTRACT

Embodiments of the present disclosure provide methods and apparatuses for processing at least one activity regarding a physical entity. A method performed by a server includes receiving monitoring data regarding at least one first physical entity from a communication device. The method further includes creating a reference model based on the monitoring data. The method further includes processing at least one activity regarding at least one second physical entity based on the reference model.

### TECHNICAL FIELD

The non-limiting and exemplary embodiments of the present disclosure generally relate to the technical field of communications, and specifically to methods and apparatuses for processing at least one activity regarding a physical entity.

### BACKGROUND

This section introduces aspects that may facilitate a better understanding of the disclosure. Accordingly, the statements of this section are to be read in this light and are not to be understood as admissions about what is in the prior art or what is not in the prior art.

There may be various relevant activities (such as a physical entity’s development, testing, debugging, maintenance, etc.) during the entire life cycle of the physical entity. In general, the processing of the relevant activities of a physical entity may be difficult than a virtual entity (such as software product). For example, a physical entity (such as various physical devices) debugging may be more difficult than a virtual entity (such as a software product) due to its natural characteristics. For example, software products may have quantities of logs for reference, even the entire environment can be restored from the backup database server located in customer’s site for maintenance team’s analysis and then a solution may be delivered. In contrast, if a physical entity were faulty or failed, it would be removed immediately by the customer and replaced with a new one to ensure the continuous services even though it has redundancy. In addition, the physical entity’s development, testing and maintenance may have more difficult than software product.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There may be some problems in processing at least one activity regarding a physical entity. For example, the physical entity’s development, testing and debugging may have more difficult than a software product due to that it can hardly be digitalized and transported via networks. A faulty physical entity cannot be packed and compressed and then sent to its maintenance team for debugging and repairing, nor its environment can hardly be re-established. All these difficulties are impediments to engineers’ productivity and efficiency.

In addition, it is hard to re-setup the environment when the physical entity went wrong, and the logs of physical entity is extremely limited or even none. Also, the maintenance engineer and the customer may use different terminology when they describe a technical situation that would result in misunderstanding of the issue of the physical entity. It would cost several days or weeks to reproduce the issue and another long period before delivering a solution. This significantly increases maintenance fee which would be covered by the customer.

In addition to the problem as mentioned above, even though the customer can clearly describe the environment of the physical entity when the faulty or failure of the physical entity happens, the maintenance team may also have some difficulties, for example,
Each physical entity issue may happen in a special case even if they are using the same component. It’s hard to refer to previous cases for debugging, the engineer has to test from the very beginning and make a conclusion step by step.
The maintenance engineer’s lab environment is quite different from the physical entity’s real operating environment at the customer site. Thus, after the repair of the physical entity, the physical entity might fail again due to a reason that is not considered in real operating environment. It’s hard for the engineer to figure out all scenarios for testing his/her solution that can cover the physical entity real environment at the customer site.
Also, some existing solutions may just consider the environmental factors of the physical entity. However, the physical entity might be highly tight to working status such as traffic data, workload, etc. The working status can’t be ignored and should be analyzed together with environmental factors.

In addition, when the maintenance team finds a solution finally, for example, a root cause turns out to be a faulty in a component, such as a capacitor, it may have so lengthy a procedure till an improvement of a component vendor. The customer can’t endure this for such long time.

Moreover, the component vendor doesn’t know in which dimension its component should be improved, e.g., a specific moisture level, a specific margin of current or voltage, or a specific aging curve of certain electronic characteristics.

In existing solutions, there are already sensors installed and/or attached to the monitored physical entity, however the captured information is somehow isolated from each other, and they are distributed too sparse, so it may not help the engineering team in an efficient way.

To overcome or mitigate at least one of the above mentioned problems or other problems, embodiments of the present disclosure propose an improved debugging solution.

In a first aspect of the disclosure, there is provided a method performed by a server. The method comprises receiving monitoring data regarding at least one first physical entity from a communication device. The method further comprises creating a reference model based on the monitoring data. The method further comprises processing at least one activity regarding at least one second physical entity based on the reference model.

In an embodiment, the monitoring data may comprise environmental data regarding the at least one first physical entity.

In an embodiment, the environmental data may be captured by at least one sensor.

In an embodiment, the at least one sensor may comprise at least one of a temperature sensor; a humidity sensor; an electromagnetic field sensor; a gas sensor; a dust sensor; a pressure sensor; a tilt sensor; an ultrasonic sensor; a force sensor; a displacement sensor; an accelerometer; a speed sensor; a radiation sensor; or a position sensor.

In an embodiment, at least one of the at least one sensor may be installed on or around the at least one first physical entity.

In an embodiment, at least one of the at least one sensor may use a same power supply with the at least one first physical entity or a power supply different from the at least one first physical entity.

In an embodiment, at least one of the at least one sensor may be placed in at least one error-prone place of the at least one first physical entity.

In an embodiment, at least one of the at least one sensor is able to be moved to another place.

In an embodiment, the monitoring data may further comprise a timestamp and/or position information indicating a capture of the monitoring data.

In an embodiment, the monitoring data may further comprise working status data of the at least one first physical entity.

In an embodiment, the working status data may comprise at least one of storage device load and status of the at least one first physical entity; computation device load and status of the at least one first physical entity; network device load and status of the at least one first physical entity; a data traffic pattern of the at least one first physical entity; a workload pattern of the at least one first physical entity; voltage data of the at least one first physical entity; or current data of the at least one first physical entity.

In an embodiment, the communication device may be an Internet of things, IoT, device.

In an embodiment, the IoT device may be installed in a place that has a minimized interference level to the at least one first physical entity.

In an embodiment, a sampling period of the monitoring data may be shorten when a big traffic flow and/or a data burst happens and may be lengthened when the at least one first physical entity is in an idle mode.

In an embodiment, a failure pattern of the at least one first physical entity may be used to correct the reference model.

In an embodiment, processing at least one activity regarding at least one second physical entity based on the reference model may comprise at least one of locating a root cause of a failure of the at least one second physical entity based on the reference model; anticipating a failure of the at least one second physical entity based on the reference model; debugging the at least one second physical entity based on the reference model; improving the at least one second physical entity based on the reference model; re-designing the at least one second physical entity based on the reference model; or designing a new second physical entity based on the reference model.

In an embodiment, the physical entity may comprise a hardware device.

In a second aspect of the disclosure, there is provided a method performed by a communication device. The method comprises obtaining monitoring data regarding at least one first physical entity. The method further comprises transmitting the monitoring data to a server. A reference model is created based on the monitoring data and at least one activity regarding at least one second physical entity is processed based on the reference model.

In a third aspect of the disclosure, there is provided a server. The server comprises a processor; and a memory coupled to the processor, said memory containing instructions executable by said processor, whereby said server is operative to receive monitoring data regarding at least one first physical entity from a communication device. Said server is further operative to create a reference model based on the monitoring data. Said server is further operative to process at least one activity regarding at least one second physical entity based on the reference model.

In a fourth aspect of the disclosure, there is provided a communication device. The communication device comprises a processor; and a memory coupled to the processor, said memory containing instructions executable by said processor, whereby said communication device is operative to obtain monitoring data regarding at least one first physical entity. Said communication device is further operative to transmit the monitoring data to a server. A reference model is created based on the monitoring data and at least one activity regarding at least one second physical entity is processed based on the reference model.

In a fifth aspect of the disclosure, there is provided a server. The server comprises a receiving module, a creating module and a processing module. The receiving module may be configured to receive monitoring data regarding at least one first physical entity from a communication device. The creating module may be configured to create a reference model based on the monitoring data. The processing module may be configured to debug at least one second physical entity based on the reference model.

In a sixth aspect of the disclosure, there is provided a communication device. The communication device comprises an obtaining module and a transmitting module. The obtaining module may be configured to obtain monitoring data regarding at least one first physical entity. The transmitting module may be configured to transmit the monitoring data to a server. A reference model is created based on the monitoring data and at least one second physical entity is debugged based on the reference model.

According to a seventh aspect of the disclosure it is provided a computer program product comprising instructions which when executed by at least one processor, cause the at least one processor to perform any of the methods according to the first and second aspects of the disclosure.

According to an eighth aspect of the disclosure it is provided computer-readable storage medium storing instructions which when executed by at least one processor, cause the at least one processor to perform any of the methods according to the first and second aspects of the disclosure.

Various embodiments herein afford various advantages, of which a non-exhaustive list of examples follows. In some embodiments herein, the proposed solution can collect all data of the customer’s on-field environment all day long. These captured data may be transferred to a storage and may be used to create a reference model. In some embodiments herein, the reference model may be updated iteratively and periodically. In some embodiments herein, the reference model may be referred to for analysis when the physical entity really goes wrong. In some embodiments herein, the reference model may be used for simulation of a potential future failure and the potential future failure may be handled in a pre-empt way. In some embodiments herein, the engineering team can improve or re-design the physical entity based on the reference model for a specific customer. In some embodiments, the engineering team can design a new physical entity which is fitter for a dedicated customer in a specified environment. In some embodiments, a component vendor can also refer to the reference model for improving its component quality in a requested dimension(s). In some embodiments, the reference model can be used by customers, device manufacturers and vendors for improving the physical entity, which is beneficial to all parties.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of a method according to an embodiment of the present disclosure;

FIG. 2 shows a flowchart of a method according to another embodiment of the present disclosure;

FIG. 3 shows an example system according to an embodiment of the present disclosure;

FIG. 4 shows an example of a layout for sensors according to an embodiment of the present disclosure;

FIG. 5 shows an example of captured data according to an embodiment of the present disclosure;

FIG. 6 shows an example of an algorithm for establishing, validating and updating a reference model according to an embodiment of the present disclosure;

FIG. 7 is a block diagram showing an apparatus suitable for practicing some embodiments of the disclosure;

FIG. 8 is a block diagram showing a server according to an embodiment of the disclosure; and

FIG. 9 is a block diagram showing a communication device according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable wireless or wired communication standards. For example, the wireless network may comprise new radio, long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols as may comprise the first generation (1G), 2G, 3G, 4G, 4.5G, 5G communication protocols, and/or any other protocols either currently known or to be developed in the future.

The term Internet of Things (IoT) device may represent a machine or other device that can perform monitoring and/or measurements, and transmit the results of such monitoring and/or measurements to a network equipment. The IoT device may be a machine-to-machine (M2M) device, which may in a 3GPP (3rd Generation Partnership Project) context be referred to as a machine-type communication (MTC) device. As one particular example, the IoT device may be a device implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, the IoT device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

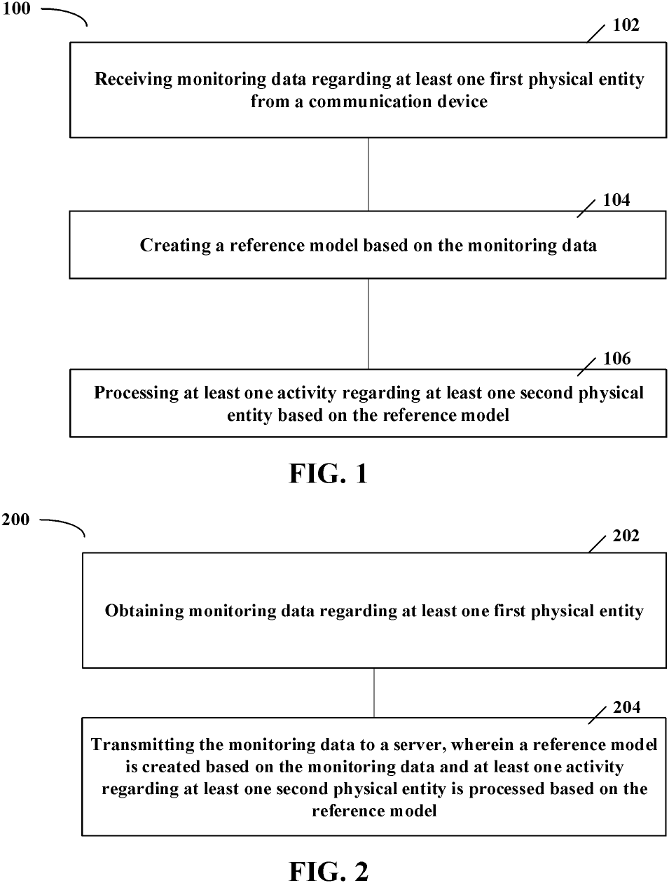

FIG. 1 shows a flowchart of a method 100 according to an embodiment of the present disclosure, which may be performed by an apparatus implemented in or as or communicatively coupled to a server or any other entity having similar functionality. As such, the apparatus may provide means or modules for accomplishing various parts of the method 100 as well as means or modules for accomplishing other processes in conjunction with other components.

The server may be a desktop computer, a cloud computer, a virtual server, a computing device, a distributed system, a vehicle infotainment system, any other type of electronic system, or any combination thereof. The server may run with any kind of operating system including, but not limited to, Windows, Linux, UNIX, Android, iOS and their variants.

At block 102, the server may receive monitoring data regarding at least one first physical entity from a communication device. The physical entity may be any suitable entity that has physical existence. For example, the physical entity may be a hardware device, such as a network node, a terminal device, a household appliances, a vehicle, a machine, or any component (such as circuit board) thereof. The communication device may be any other suitable device which can support communication function. For example, the communication device may be a network node, a terminal device, a household appliances, a vehicle, a machine, etc. In an embodiment, the communication device may be the physical entity if the physical entity supports communication function.

The term “network node” refers to a network device with accessing function in a communication network via which a terminal device accesses to the network and receives services therefrom. The network node may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (IAB) node, a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

The monitoring data may comprise any suitable data which can be obtained and/or required to be obtained. In an embodiment, the monitoring data may comprise environmental data regarding the at least one first physical entity. The environmental data may include at least one of temperature data; humidity data; electromagnetic field data; gas data; dust data; pressure data; tilt data; ultrasonic data; force data; displacement data; accelerometer data; speed data; radiation data; or position data.

In an embodiment, the environmental data is captured by at least one sensor. The at least one sensor may be any suitable sensor which can obtain the environmental data regarding at least one first physical entity.

In an embodiment, the at least one sensor comprises at least one of a temperature sensor; a humidity sensor; an electromagnetic field sensor; a gas sensor; a dust sensor; a pressure sensor; a tilt sensor; an ultrasonic sensor; a force sensor; a displacement sensor; an accelerometer; a speed sensor; a radiation sensor; or a position sensor.

In an embodiment, at least one of the at least one sensor is installed on or around the at least one first physical entity. For example, at least one of the at least one sensor may be component of the at least one first physical entity and in this case it may be installed on the at least one first physical entity. As another example, when the at least one of the at least one sensor is a device independent of the at least one first physical entity, the at least one of the at least one sensor may be installed around the at least one first physical entity. As still another example, some sensor(s) may be installed on the at least one first physical entity and the other sensor(s) may be installed around the at least one first physical entity.

In an embodiment, at least one of the at least one sensor uses a same power supply with the at least one first physical entity.

In an embodiment, at least one of the at least one sensor uses a power supply different from the at least one first physical entity.

For example, at a physical entity side, there may be some typical designs which can be applied on a new physical entity and a legacy (existing) physical entity separately or combined depending on which monitoring data is collected.

A first design is “on-board” design, which means the sensor may use a same power supply as the physical entity, an advantage of “on-board” design is that the overall cost can be reduced at deployment, but a disadvantage of “on-board” design is that when any sensor itself goes wrong, it may send incorrect data that may impact reference model analysis and establishment.

A second design is “monitoring” design, which means the sensor is self-powered or using another power supply, an advantage of “monitoring” design is that some legacy physical entity can also enjoy the benefit of the proposed solution according to some embodiments of the present disclosure. Also, it’s more flexible as the sensors can change their positions automatically or manually.

A third design is a combination of the “on-board” design and the “monitoring” design, which means at least one sensor may be self-powered or use another power supply and at least one other sensor may use the same power supply as the physical entity.

The at least one sensor may be placed in any suitable place. In an embodiment, at least one of the at least one sensor is placed in at least one error-prone place of the at least one first physical entity.

For example, at least one sensor may be placed in the most error-prone places of the physical entity and may capture data and transfer the data to the server for example for further analysis and use.

In an embodiment, at least one of the at least one sensor is able to be moved to another place. For example, an sensor may be moved to another place by using any suitable mechanical device.

In an embodiment, the at least one sensor may be time synchronized. For example, In an embodiment, the at least one sensor may be time synchronized with the at least one first physical entity.

In an embodiment, the monitoring data further comprises a timestamp and/or position information indicating a capture of the monitoring data.

In some cases, a physical entity (such as hardware) relevant case (faulty, failure, bug, etc.) is not only related to the physical entity’s working environment parameters, such as humidity, temperature and electromagnetic, but also highly related to the physical entity’s own working status. In an embodiment, the monitoring data further comprises working status data of the at least one first physical entity. The working status data of the at least one first physical entity may comprise any suitable working status data of the at least one first physical entity. The monitoring data may bring much hints which may be used by an engineering team to analyze a root cause of the physical entity relevant case.

In an embodiment, the monitoring data may be time synchronized. For example, the environmental data and the working status data may be time synchronized.

In an embodiment, the working status data comprises at least one of storage device load and status of the at least one first physical entity; computation device load and status of the at least one first physical entity; network device load and status of the at least one first physical entity; a data traffic pattern of the at least one first physical entity; a workload pattern of the at least one first physical entity; voltage data of the at least one first physical entity; or current data of the at least one first physical entity.

For example, the work status data may comprise the traffic status on a network card, the load status of a CPU, etc. The working status data may comprise a data traffic pattern on a circuit board, a workload pattern on the circuit board and other perspective pattern that may reflect the circuit board’s working status.

In an embodiment, the communication device is an IoT device.

The communication device may be installed in any suitable place. In an embodiment, the communication device such as IoT device may be installed in a place that has a minimized interference level to the at least one first physical entity.

A sampling period of the monitoring data may be predefined or changed. In an embodiment, the sampling period of the monitoring data may be shorten when a big traffic flow and/or a data burst happens and may be lengthened when the at least one first physical entity is in an idle mode.

At block 104, the server may create a reference model based on the monitoring data. The server may create the reference model based on the monitoring data by using any suitable modeling techniques such as Data Driven Modeling (DDM). If enough monitoring data as well as their corresponding cases are collected, a reference (such as simulation) model could be established for future reference. The reference model can even be shared for another physical entity which is used in a same or similar environment to reduce the establishment time of reference model for another physical entity. In an embodiment, the reference model may be created for each type of the monitoring data.

When the reference (such as simulation) model is established, it can evolve iteratively in a periodical manner automatically or manually. In an embodiment, a failure pattern of the at least one first physical entity is used to correct the reference model.

At block 106, the server may process at least one activity regarding at least one second physical entity based on the reference model. The at least one activity may comprises any suitable activity such as the physical entity’s designing, redesigning, development, testing, debugging, maintenance, etc. The second physical entity may be of a same type of physical entity as the first physical entity. Alternatively, the second physical entity may be of a similar type of physical entity as the first physical entity. For example, the second physical entity may be a revised version of the first physical entity. In general both the first physical entity and the second physical entity may work or be located in a same or similar environment.

In an embodiment, the server may process at least one activity regarding at least one second physical entity based on the reference model by performing at least one of locating a root cause of a failure of the at least one second physical entity based on the reference model; anticipating a failure of the at least one second physical entity based on the reference model; debugging the at least one second physical entity based on the reference model; improving the at least one second physical entity based on the reference model; re-designing the at least one second physical entity based on the reference model; or designing a new second physical entity based on the reference model.

FIG. 2 shows a flowchart of a method 200 according to another embodiment of the present disclosure, which may be performed by an apparatus implemented in or as or communicatively coupled to a communication device or any other entity having similar functionality. As such, the apparatus may provide means or module for accomplishing various parts of the method 200 as well as means for accomplishing other processes in conjunction with other components. For some parts which have been described in the above embodiments, detailed description thereof is omitted here for brevity.

At block 202, the communication device may obtain monitoring data regarding at least one first physical entity. For example, the communication device may obtain environmental data regarding the at least one first physical entity from at least one sensor. The communication device may obtain working status data of the at least one first physical entity from the at least one first physical entity.

At block 204, the communication device may transmit the monitoring data to a server. As described above, a reference model is created based on the monitoring data and at least one activity regarding at least one second physical entity is processed based on the reference model.

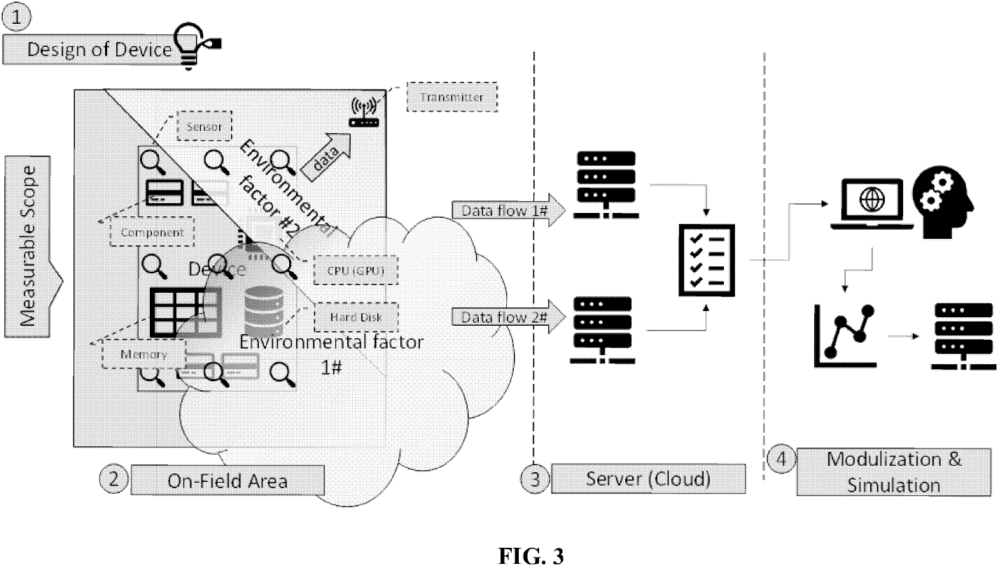

FIG. 3 shows an example system according to an embodiment of the present disclosure.

As shown in FIG. 3, “design -> deployment -> maintenance -> re-design (improvement)” may be a closed loop just like the evolution model in software domain.

In FIG. 3, there are four stages of a hardware device lifecycle.

A first stage is hardware device design. In this stage, hardware and software engineers work together to align in below perspective:
Where the sensors may be placed (if using the same power supply as the hardware device) or attached (if self-powered or using another power supply).
How the software sends working status data to a transmitter (e.g., the communication device) together with the data that captured by sensors. For example, when big traffic flow happens or data burst, the data sampling period may be shortened by both software and hardware; and when the hardware device is in idle mode, the data sampling period may be longer to save the bandwidth of the transmitter.

A second stage is deployment. In this stage, the transmitter may be installed in the place that in a minimized interference level to the hardware device, and it should be able to get signals from all sensors. If a sensor is independent from the hardware device, its installation place may be the position that is defined in the first stage.

As shown in the FIG. 3, there are totally 9 sensors installed for detecting environmental factor data. Environmental factor 1# is electromagnetic interference whoes distribution is somehow randomly. In contrast, environmental factor 2# is a humidity level which can be modelized as a gradient triangle.

In a shape of each environmental factor, there are different sensors installed for monitoring data to sensitive components. For example, a hard disk may be more sensitive to electromagnetic interference, thus there may be a magnetometer installed on top of it. If the humidity is in a moderate level, a humidity sensor may be installed on top of the hard disk.

For example, if a workload of this hard disk is rather high, then its own heat output might already be enough to disperse the humidity. In this situation, the humidity sensor may work in a “slow” mode, which means it may collect the humidity data for example once per several hours or even per day. In contrast, if the hard disk is always in an idle state, then the humidity sensor may work more actively, especially when it detects any abnormal humidity level which might harmful to the hard disk.

If these sensors are independent from the monitored hardware device, they can be moved when there is any signification change in a pre-defined path.

A third stage is storing and analysis. In this stage, the captured and collected data may be organized in a uniformed way.

A fourth stage is modulization and simulation. In this stage, the engineering team may use the captured data to create a reference model, and with the issued cases on-field, to find out a failure pattern of each category. This procedure may last for months or even years in order to create a reliable reference model.

After a reference model is created, it can be used for other or future similar designs and anticipate the failure. Also, a failure pattern can be used as a correction or enhancement to the reference model.

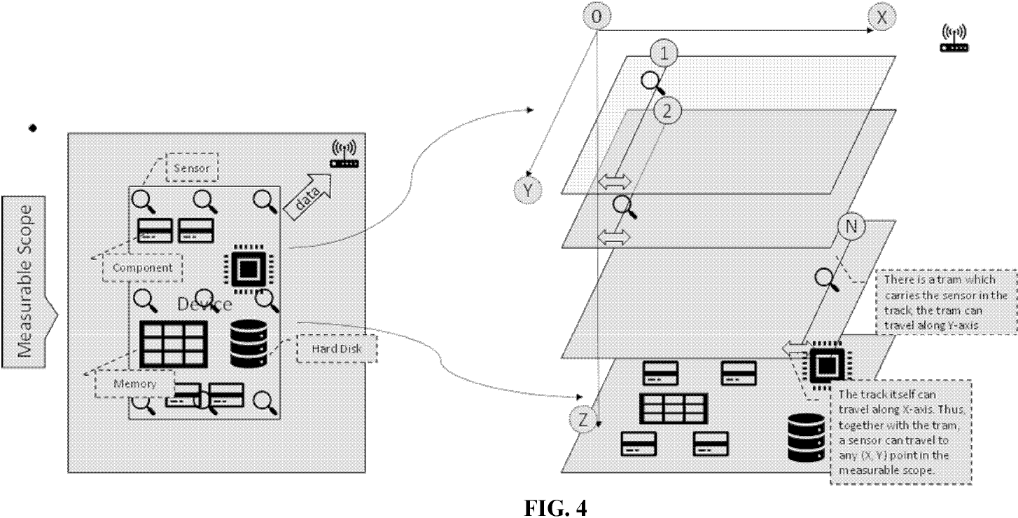

FIG. 4 shows an example of a layout for sensors according to an embodiment of the present disclosure.

As shown in FIG. 4, in Z-axis on the right drawing, there are totally N+1 layers, the bottom layer is the hardware device (e.g., a PCB (Printed circuit board)) to be monitored. The upper N layers are for sensors. For example, N may equal to the count of sensors.

In this embodiment, N = 9 as shown in the left drawing of FIG. 4. The space between each layer may be larger than the dimension of the sensor and its tram to ensure that when sensors are travelling, there won’t be conflict.

In an embodiment, at least one sensor may have an overall planning to decide in which layer they may travel. For example, if a sensor is to detect the electromagnetic field changes which may be significantly difference even if in a tiny space, then it may be installed in Nth layer (which is the nearest layer to the hardware device). If it’s a humidity or gas sensor, it may be installed in the first layer.

A sensor may travel in any point in its layer. In this way, the sensor can collect a lot of environmental data so long as the sampling frequency of the sensor may be not too high.

If needed, a sensor may travel in three dimensions so long as its track is not conflict with another sensor. This design may be useful for the electromagnetic field changes which may have the requirement to get a 3-D (three dimension) model sometimes.

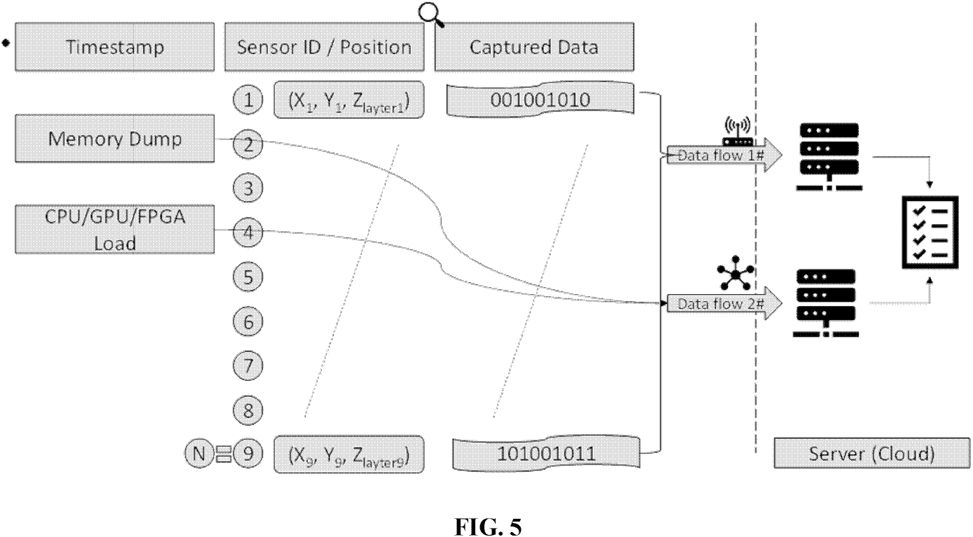

FIG. 5 shows an example of captured data according to an embodiment of the present disclosure.

As shown in FIG. 5, in a data structure of a package that is transmitted to the server (cloud), the data captured by sensors may be transmitted in a timestamped data package that may include at least one of below information: (1) a timestamp and (2) the captured data with its sensor ID (identity) and its position such as the position coordinate (X, Y, Z).

The captured data regarding at least one physical entity may be transmitted to a storage in the server (cloud) for analysis or future reference via the transmitter (e.g., the communication device).

In addition, working status data regarding at least one physical entity may be transmitted to another storage whose capacity is larger than the above one in the sever (cloud). The following working status data may be stored for joint analysis and reference by engineers, R&D (research and development) people and the vendor:
The memory dump, especially for any abnormal or extreme environmental factor happens.
The processor working load and status, such as CPU(Central Processing Unit), GPU (graphics processing unit) and/or FPGA (field-programmable gate array) working load and status.

The working status data may also be transmitted in a same timestamp of the captured data package.

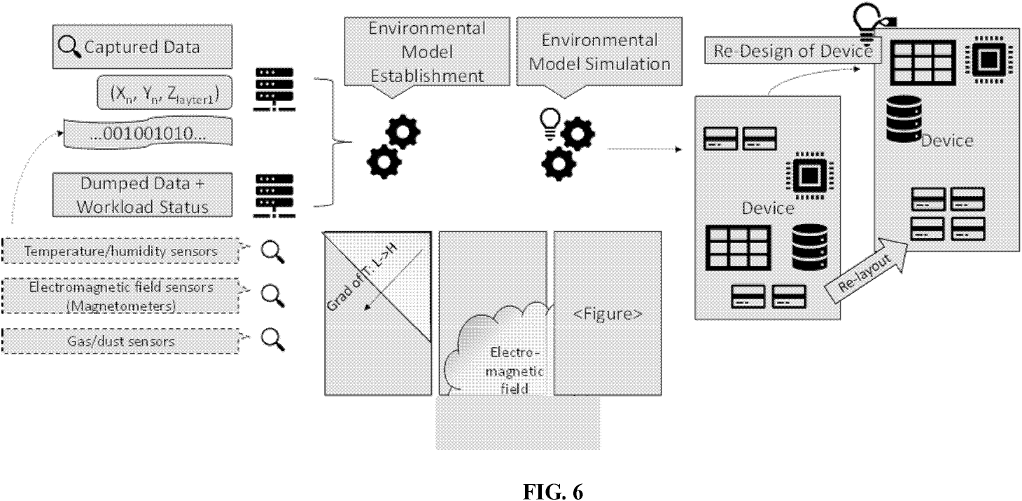

FIG. 6 shows an example of an algorithm for establishing, validating and updating a reference model according to an embodiment of the present disclosure.

As shown in FIG. 6, there may be three stages of establishment, validation, update and simulation. The algorithm starts from the hardware device in the real world, and validation & simulation, then finally feedback the real world. It’s a closed loop to hardware (re-)design for a dedicated environment.

In a first stage, at least one sensor may travel around a measurable scope in a pattern (e.g., travel path and velocity), then based on a real situation, it may capture data in a frequency. The travel path, velocity and the sampling frequency can be pre-defined and adjusted automatically or manually.

After a full traversal, a model can be created in all categories. For example, the model shape of temperature and humidity tends to be a gradient distribution, it can be easily known where the highest temperature and/or humidity is. The model shape of electromagnetic field is more complex, but it is easy to get the data of its strength and know where is the area that has most electromagnetic interference. The model shape of gas and dust may be the simplest one, it may have a figure with tiny difference level within the measurable scope.

In a second stage, the established model may be validated for example as below.

Comparing the device’s performance and electromagnetic characters with the design destination in device level and component level. The component vendor can re-check whether their components characters meet their design target as well.

Both device manufacturer and component vendor can continuously collect such data for improving their products, and when the device or component went failure or faulty, they can get the failure curve based on a specified environment. Thus, if any other device is installed in a same or similar environment, it can anticipate an estimated failure date to validate whether the reference model is suitable, if not, the consequence failures in the similar environment can be used as corrections to update the reference model.

In a third stage, the validated and updated model may be an input to a simulated model. For example, it can be implemented in below way.

If a device needs to be deployed in a new environment, for example those environments with many interference factors that would impact the device performance or have potential deterioration factors to some certain component.

Then a simulation model can be created by referring to the existing reference models (as described in the first and second stages), and the device specification may be set into the model and run simulation in a computer to find out whether the device is fit for this specified environment. The simulation (or reference) model can also be established by sensors prior installed on the field to create a more accurate model.

The simulation result may be an input for both a device manufacturer and a component vendor to improve their product before the real production, which can reduce R&D and design cost.

Based on all these facts as shown in FIG. 6, it can be analyzed that how the environmental factor exists and their “shape” in the measurable scope, then in a future re-design for improvement, these captured data can be referred to for a better device design (such as PCB layout) to avoid interference factors.

According to various embodiments, in an existing solution, such as MATLAB, that provides environment interference factor model establishment and simulation, the existing solution may just use some parameters to define the model. However, the disadvantage of the existing solution (such as MATLAB) is that the established model is still far away from the real world, especially the electromagnetic field which may be in irregular shapes and changes dynamically as times goes by.

According to various embodiments, the proposed solution is able to capture, from the real world, not only the environmental factor data but also the information (such as working status) of the device itself, such as memory dump and processor workload data. By combining all relevant information together, the related people such as device manufacture can have enough data to improve the device design or provide a customized design. Moreover, the component vendor can know where their products are used and how to improve their products’ quality or even also provide customized productions just like what software company does.

According to various embodiments, the proposed solution may use the captured data to establish a simulation model (or reference model) that can be evolved by R&D and engineering teams more accurately and targeted for a specified environment. For example, an environment may be exposed to huge electromagnetic interference or intensive radio rays. Based on the reference model, the device manufacture and/or component vendor can make a more dedicated design for that environment. Moreover, some environments are dangerous for human to measure, and the proposed solution can provide an safe method to obtain both the environment data and the working status data.

According to various embodiments, the proposed solution can be applied in remote areas for monitoring the devices installed there, as the inspection and maintenance fee by human may be rather high and the devices may require a good robustness in design.

Various embodiments herein afford various advantages, of which a non-exhaustive list of examples follows. In some embodiments herein, the proposed solution may collect all data of a customer’s on-field environment all day long. The captured data may be transferred to a storage and may be used to create a reference model. In some embodiments herein, the reference model may be updated iteratively and periodically. In some embodiments herein, the reference model may be referred to for analysis when the physical entity really goes wrong. In some embodiments herein, the reference model may be used for simulation of a potential future failure and the potential future failure can be handled in an pre-empt way. In some embodiments herein, the engineering team can improve or re-design the physical entity based on the reference model for a specific customer. In some embodiments, the engineering team can design a new physical entity which is fitter for a dedicated customer in a specified environment. In some embodiments, a component vendor can also refer to the reference model for improving its component quality in a requested dimension(s). In some embodiments, the reference model can be used by customers, device manufacturers and vendors for improving the physical entity, which is beneficial to all parties.

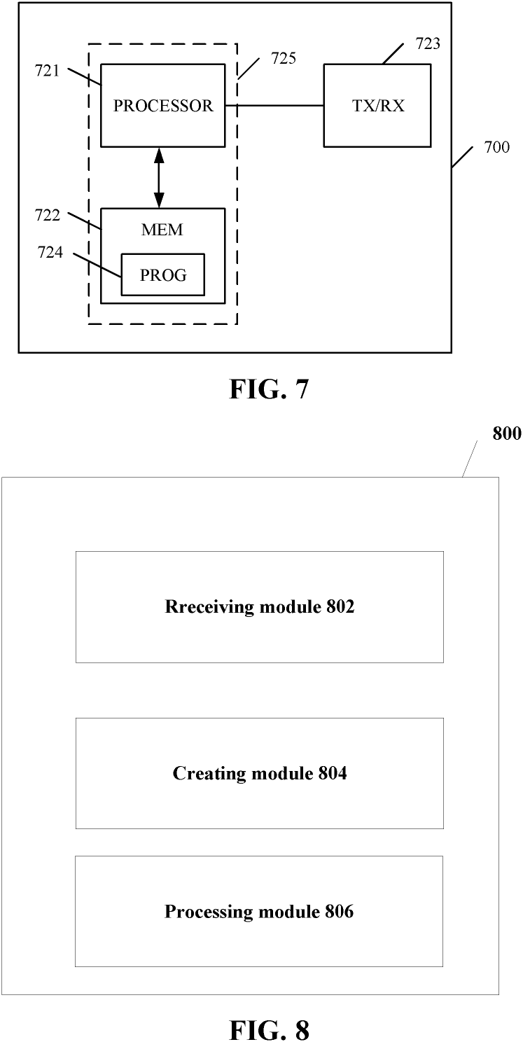

FIG. 7 is a block diagram showing an apparatus suitable for practicing some embodiments of the disclosure. For example, any one of the communication device and the server as described above may be implemented as or through the apparatus 700.

The apparatus 700 comprises at least one processor 721, such as a DP (digital processor), and at least one MEM (memory) 722 coupled to the processor 721. The apparatus 720 may further comprise a transmitter (TX) and receiver (RX) 723 coupled to the processor 721. The MEM 722 stores a PROG (program) 724. The PROG 724 may include instructions that, when executed on the associated processor 721, enable the apparatus 720 to operate in accordance with the embodiments of the present disclosure. A combination of the at least one processor 721 and the at least one MEM 722 may form processing means 725 adapted to implement various embodiments of the present disclosure.

Various embodiments of the present disclosure may be implemented by computer program executable by one or more of the processor 721, software, firmware, hardware or in a combination thereof.

The MEM 722 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 721 may be of any type suitable to the local technical environment, and may include one or more of general purpose computers, special purpose computers, microprocessors, digital signal processors DSPs (digital signal processors) and processors based on multicore processor architecture, as non-limiting examples.

In an embodiment where the apparatus is implemented as or at the server, the memory 722 contains instructions executable by the processor 721, whereby the server operates according to the method 100 as described in reference to FIG. 1.

In an embodiment where the apparatus is implemented as or at the communication device, the memory 722 contains instructions executable by the processor 721, whereby the communication device operates according to the method 200 as described in reference to FIG. 2.

FIG. 8 is a block diagram showing a server according to an embodiment of the disclosure. As shown, the server 800 comprises a receiving module 802, a creating module 804 and a processing module 806. The receiving module 802 may be configured to receive monitoring data regarding at least one first physical entity from a communication device. The creating module 804 may be configured to create a reference model based on the monitoring data. The processing module 806 may be configured to process at least one activity regarding at least one second physical entity based on the reference model.

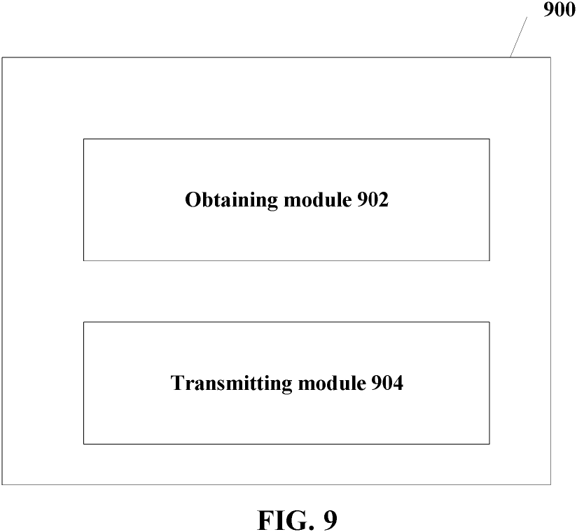

FIG. 9 is a block diagram showing a communication device according to an embodiment of the disclosure. As shown, the communication device 900 comprises an obtaining module 902 and a transmitting module 904. The obtaining module 902 may be configured to obtain monitoring data regarding at least one first physical entity. The transmitting module 904 may be configured to transmit the monitoring data to a server. A reference model is created based on the monitoring data and at least one activity regarding at least one second physical entity is processed based on the reference model.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, any of the server and the communication device may not need a fixed processor or memory, any computing resource and storage resource may be arranged from any of the server and the communication device in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods 100 and 200 as described above.

According to an aspect of the disclosure it is provided a computer-readable storage medium storing instructions which when executed by at least one processor, cause the at least one processor to carry out any of the methods 100 and 200 as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

What is claimed is:

1. A method performed by a server, comprising:
receiving monitoring data regarding at least one first physical entity from a communication device;
creating a reference model based on the monitoring data; and
processing at least one activity regarding at least one second physical entity based on the reference model.

2. The method according to claim 1, wherein the monitoring data comprises environmental data regarding the at least one first physical entity.

3. The method according to claim 2, wherein the environmental data is captured by at least one sensor.

4. The method according to claim 3, wherein the at least one sensor comprises at least one of:
a temperature sensor;
a humidity sensor;
an electromagnetic field sensor;
a gas sensor;
a dust sensor;
a pressure sensor;
a tilt sensor;
an ultrasonic sensor;
a force sensor;
a displacement sensor;
an accelerometer;
a speed sensor;
a radiation sensor; or
a position sensor.

5. The method according to claim 3, wherein at least one of the at least one sensor is installed on or around the at least one first physical entity.

6. The method according to claim 3, wherein at least one of the at least one sensor uses a same power supply with the at least one first physical entity or a power supply different from the at least one first physical entity.

7. The method according to claim 3, wherein at least one of the at least one sensor is placed in at least one error-prone place of the at least one first physical entity.

8. The method according to claim 3, wherein at least one of the at least one sensor is able to be moved to another place.

9. The method according to claim 1, wherein the monitoring data further comprises a timestamp and/or position information indicating a capture of the monitoring data.

10. The method according to claim 1, wherein the monitoring data further comprises working status data of the at least one first physical entity.

11. The method according to claim 10, wherein the working status data comprises at least one of:
storage device load and status of the at least one first physical entity;
computation device load and status of the at least one first physical entity;
network device load and status of the at least one first physical entity;
a data traffic pattern of the at least one first physical entity;
a workload pattern of the at least one first physical entity;
voltage data of the at least one first physical entity; or
current data of the at least one first physical entity.

12. The method according to claim 1, wherein the communication device is an Internet of things, IoT, device.

13. The method according to claim 12, wherein the IoT device is installed in a place that has a minimized interference level to the at least one first physical entity.

14. The method according to claim 1, wherein a sampling period of the monitoring data is shorten when a big traffic flow and/or a data burst happens and is lengthened when the at least one first physical entity is in an idle mode.

15. The method according to claim 1, wherein a failure pattern of the at least one first physical entity is used to correct the reference model.

16. The method according to claim 1, wherein processing at least one activity regarding at least one second physical entity based on the reference model comprises at least one of:
locating a root cause of a failure of the at least one second physical entity based on the reference model;
anticipating a failure of the at least one second physical entity based on the reference model;
debugging the at least one second physical entity based on the reference model;
improving the at least one second physical entity based on the reference model;
re-designing the at least one second physical entity based on the reference model; or
designing a new second physical entity based on the reference model.

17. The method according to claim 1, wherein the physical entity comprises a hardware device.

18. A method performed by a communication device, comprising:
obtaining monitoring data regarding at least one first physical entity; and
transmitting the monitoring data to a server,
wherein a reference model is created based on the monitoring data and at least one activity regarding at least one second physical entity is processed based on the reference model.

19. The method according to claim 18, wherein the monitoring data comprises environmental data regarding the at least one first physical entity.

20-33. (canceled)

34. A server, comprising:
a processor; and
a memory coupled to the processor, said memory containing instructions executable by said processor, whereby said server is operative to:
receive monitoring data regarding at least one first physical entity from a communication device;
create a reference model based on the monitoring data; and
process at least one activity regarding at least one second physical entity based on the reference model.

35-39. (canceled)
